(19) United States
(12) Patent Application Publication
(10) Pub. No.: US 2020/0088868 A1
(43) Pub. Date: Mar. 19, 2020

(54) VEHICLE SPEED RADAR SYSTEM AND DETECTION METHOD THEREOF

(71) Applicant: CUBTEK INC., Zhubei City (TW)

(72) Inventors: SAN-CHUAN YU, Zhubei City (TW); SHYH-JONG CHUNG, Zhubei City (TW); HONG-LUN CHEN, Zhubei City (TW)

(21) Appl. No.: 16/198,314

(22) Filed: Nov. 21, 2018

(30) Foreign Application Priority Data
Sep. 13, 2018 (TW) 107132305

(51) Int. Cl. G01S 13/60; G01S 13/93

(52) U.S. Cl. CPC G01S 13/60; G01S 2013/9353; G01S 13/931

(57) ABSTRACT

A vehicle speed radar system and detection method are provided. The radar system is disposed on a vehicle for determining the speed status of a target vehicle. The radar system includes a transmitting unit, a receiving unit, a self speed detection unit, a signal processing unit, and a rational speed determination unit. The transmitting unit sends out a wave source which is reflected by the target vehicle and received by the receiving unit, and a frequency value is acquired. The self speed detection unit acquired a first absolute speed. The signal processing unit acquires a relative speed, and acquires possible second absolute speeds of the target vehicle according to the first absolute speed and the relative speed. The rational speed determination unit determines the rational second absolute speed, so as to resolve the irrational determination of the speed status of the vehicle.

### BACKGROUND OF THE INVENTION

### 1. Field of the Invention

The present invention relates to vehicle speed radar systems, and more particularly, to a vehicle speed radar system for determining if the speed of the vehicle and the target vehicle are rational.

### 2. Description of the Related Art

As for conventional vehicle speed radar system, the speed detection is carried by application of Doppler Effect, wherein the system sends out a wave source with a transmission unit, such that when the wave source engages with the target vehicle, a reflection of the wave source is produced, and a receiving unit receives a frequency value. Then, the system converts the frequency to acquire a relative speed between the system carrying vehicle and the target vehicle.

The receiving unit of the conventional vehicle radar system has a frequency sampilng range. If the frequency value received by the receiving unit exceeds the frequency sampilng range, a conversion is carried out to acquire the equivalent frequency value in the frequency sampilng range, and the system converts the equivalent frequency to acquire the relative speed of the target vehicle. However, the relative speed thereby acquired might differ from the actual relative speed.

When the frequency sampilng range of the receiving unit of a vehicle speed radar system is 9600 Hz (±4800 Hz), it means that if the sampled frequency ranges between +4800 Hz to −4800 Hz, the detection result of the radar system is correct. For example, if the system receives a frequency value of 3840 Hz, based on the relative speed conversion formula, the target vehicle moves away from the system carrying vehicle by a relative speed of 87 km/hour. However, due to the limitation of the receivable frequency value of the radar system, if the sampled frequency is higher than +4800 Hz or lower than −4800 Hz, the value acquired by the radar system might be incorrect. For example, if the actual sampled frequency received by the receiving unit is −5760 Hz, it accordingly means that the target vehicle moves toward the system carrying vehicle by a relative speed of 130 km/hour. However, because the receiving frequency exceeds the limitation of the frequency sampling range, such frequency value is conversed by the Fourier transform into an equivalent frequency as 3840 Hz, which is acquired by the system. In other words, the actual frequency of −5760 Hz indicates that the target vehicle is getting closer to the system carrying vehicle by a relative speed of 130 km/hour, but the system incorrectly acquires a frequency of 3840 Hz, causing an error indication that the target vehicle is getting away from the system carrying vehicle by a relative speed of 87 km/hour, resulting an irrational vehicle speed determination. In other words, a dangerous situation of a vehicle moving closer in high speed is incorrectly identified as a safe situation of the vehicle moving away. Under such circumstance, a hazardous result of rear-end collision may be difficult to be prevented.

For conventional radar system to resolve the irrational determination of the vehicle speed situation aforementioned, the frequency sampilng range of the receiving unit shall be increased. However, such resolution increases the cost of the vehicle radar system.

### SUMMARY OF THE INVENTION

For improving the issues above, a vehicle radar system and the detection method thereof are provided, wherein the rational vehicle determination unit is able to determine a rational second absolute speed.

A vehicle radar system in accordance with an embodiment of the present invention is provided, which is disposed on a main vehicle for determining a relative speed status with respect to a target vehicle. The vehicle radar system comprises:

a transmitting unit sending out a wave source;

a receiving unit receiving the wave source when the wave source is reflected by the target vehicle, so as to acquire a frequency value;

a self speed detection unit acquiring a first absolute speed of the main vehicle;

a signal processing unit electrically connected with the receiving unit and the self speed detection unit, so as to acquire at least one possible relative speed between the main vehicle and the target vehicle, and acquire at least one possible second absolute speed of the target vehicle based on the first absolute speed and the at least one relative speed; and

a rational speed determination unit electrically connected with the signal processing unit, so as to determine a rational second absolute speed from the at least one possible second absolute speed.

The present invention also provide a detection method of a vehicle speed radar system, comprising following steps:

(a) the transmitting unit sending a wave source;

(b) the receiving unit receiving the wave source reflected by the target vehicle and acquiring the frequency value;

(c) the self speed detection unit acquiring the first absolute speed of the main vehicle;

(d) the signal processing unit converting the frequency value to acquire at least one relative speed, and acquiring at least one possible second absolute speed of the target vehicle based on the first absolute speed and the at least one relative speed;

(e) the rational speed determination unit determining a rational second absolute speed from the at least one possible second absolute speed.

With such configuration and method, the first absolute speed is acquired by the self speed detection unit when receiving the frequency value, the signal processing unit acquires at least one relative speed so as to acquire at least one second absolute speed of the target vehicle, and the rational speed determination unit determines the rational second absolute speed. Therefore, the vehicle speed status of the target vehicle is rationally determined, thus receiving the cost demand caused by improvement of the receiving unit frequency sampilng range of the conventional vehicle speed radar system. Also, possible rear-end collision caused by the target vehicle is effectively prevented.

Furthermore, the vehicle speed radar system further includes a signal strength determination unit. After the wave source is reflected by the target vehicle to be received by the receiving unit, the signal strength determination unit determines the signal strength of the reflected wave source. A gradual rising of the signal strength indicates that the target vehicle is getting closer to the main vehicle. In contrast, a gradual reduction of the signal strength indicates that the target vehicle is getting away from the main vehicle. Therefore, the signal strength determination unit, by determining whether the target vehicle is getting closer to or away from the main vehicle, assists to confirm if the speed status between the target vehicle and the main vehicle matches the status determined based on the frequency detection result, so as to assist the rational speed determination unit to determine the accuracy of the second absolute speed of the target vehicle.

### BRIEF DESCRIPTION OF THE DRAWINGS

FIG. 1 is a block diagram of the vehicle speed radar system in accordance with an embodiment of the present invention.

FIG. 2 is a schematic view illustrating the vehicle speed radar system applied for detecting the target vehicle.

FIG. 3 is another schematic view illustrating the vehicle speed radar system applied for detecting the target vehicle.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

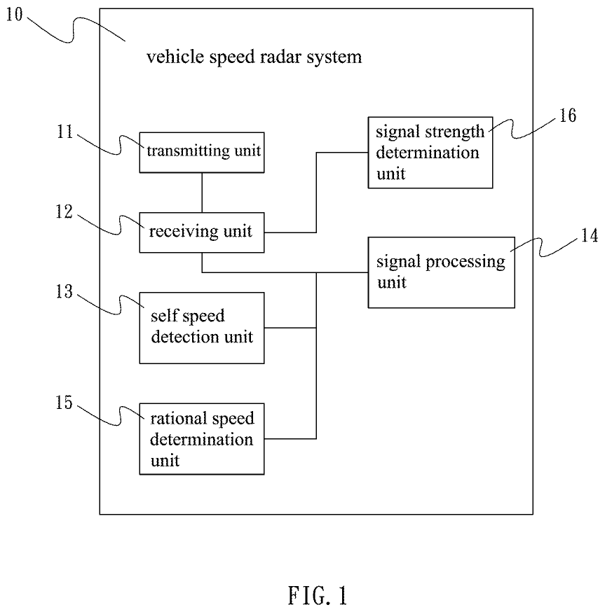

Referring to FIG. 1 to FIG. 3, a vehicle speed radar system 10 and detection method thereof are provided. The vehicle speed radar system 10 in accordance with an embodiment of the present invention, as shown by FIG. 1, comprises a transmitting unit 11, a receiving unit 12, a self speed detection unit 13, a signal processing unit 14, and a rational speed determination unit 15. The vehicle speed radar system 10 is disposed on a main vehicle 20 for determining a speed status of a target vehicle 30.

The transmitting unit 11 sends out a wave source, which will be reflected and then received by the receiving unit 12. The receiving unit 12 is electrically connected with the signal processing unit 14. The receiving unit 12, after receiving the reflected wave source, produces a frequency value, which is then received by the signal processing unit 14 to be processed, such that a relative speed corresponding to the frequency value is acquired. The self speed detection unit 13 is electrically connected with the signal processing unit 14, so as to receive the first absolute speed of the main vehicle 20. The rational speed determination unit 15 is electrically connected with the signal processing unit 14, so as to determine the second absolute speed of the target vehicle 30.

In a preferred embodiment, the vehicle speed radar system 10 includes a signal strength determination unit 16 which is electrically connected with the receiving unit 12. When the reflected wave source is received by the receiving unit 12, the signal strength determination unit 16 determines the signal strength of the received wave source. Therein, a gradual rising of the signal strength indicates that the target vehicle 30 is getting closer to the main vehicle 20. In contrast, a gradual reduction of the signal strength indicates that the target vehicle 30 is getting away from the main vehicle 20.

The present invention also provides a detection method of the vehicle speed radar system 10. The transmitting unit 11 sends out a wave source from the main vehicle 20. The wave source meets the target vehicle 30 and is reflected by the target vehicle 30. When the reflected wave source is received by the receiving unit 12, a frequency value is produced. When the frequency value is acquired, the self speed determination unit 13 also acquires a first absolute speed of the main vehicle 20. Next, the signal processing unit 14 converts the frequency value to acquire a plurality of possible relative speeds, and also acquires a plurality of second absolute speeds of the target vehicle 30 according to the first absolute speed and the possible relative speeds, wherein the plurality of second absolute speeds corresponding to the possible relative speeds, respectively.

For example, the wave source sent out by the transmitting unit 11 of the vehicle speed radar system 10 of the main vehicle 20 is 24 GHz, and the frequency sampling range of the receiving unit 12 is 9600 Hz (±4800 Hz). When the receiving unit 12 receives a frequency value which is converted by the signal processing unit 14 into 3840 Hz, the actual frequency values might possibly be 3840 Hz or 3840 Hz±n*9600 Hz. In other words, the actual frequency might be −5760 Hz, which obviously exceeds the 9600 Hz (±4800 Hz) frequency sampling range, and has been converted by the signal processing unit 14 through Fourier transform into an equivalent 3840 Hz frequency value. If the acquired frequency value is −5760 Hz, it indicates that the main vehicle 20 is getting closer to the target vehicle 30 at a relative speed of 130 km/hour. If the acquired frequency value is 3840 Hz, it indicates that the main vehicle 20 is getting away from the target vehicle 30 at a relative speed of 87 km/hour. The conversion formula of the relative speed is: Hz=2×relative speed×24/0.3.

Then, according to the first absolute speed, the rational speed determination unit 15 determines a rational second absolute speed form the possible second absolute speeds. In a preferred embodiment, the rational speed determination unit 15 selects the smallest one of the possible second absolute speeds as the rational second absolute speed.

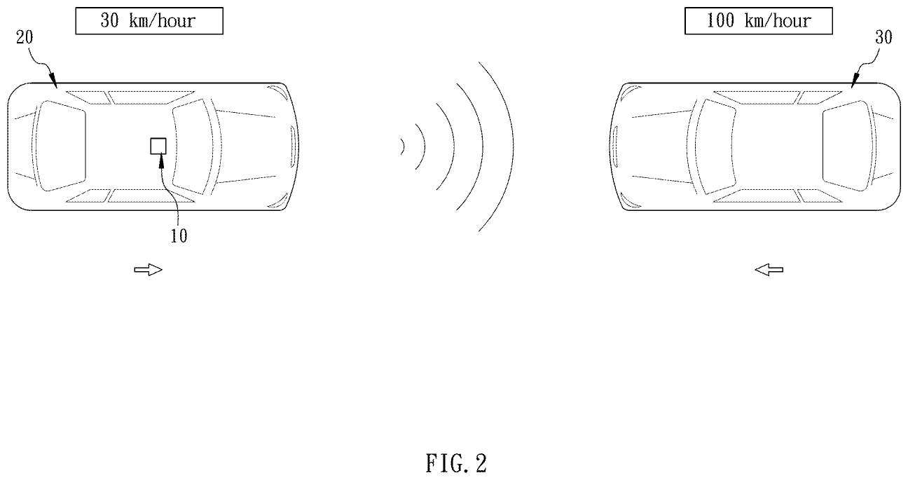

Referring to FIG. 2, the receiving unit 12 receives an actual frequency value of −5760 Hz, and the signal processing unit 14 converts the frequency value into an equivalent 3840 Hz. Also, the first absolute speed of the main vehicle 20 is 30 km/hour. When the relative speed is 130 km/hour (two vehicles getting closer) or 87 km/hour (two vehicles getting away), the second absolute speed of the target vehicle 30 is either 100 km/hour toward the main vehicle 20 or 117 km/hour away from the main vehicle 20. Based on the fact that the rational speed determination unit 15 determines a smaller second absolute speed as the rational second absolute speed, the rational second absolute speed of the target vehicle 30 shall be 100 km/hour toward the main vehicle 20.

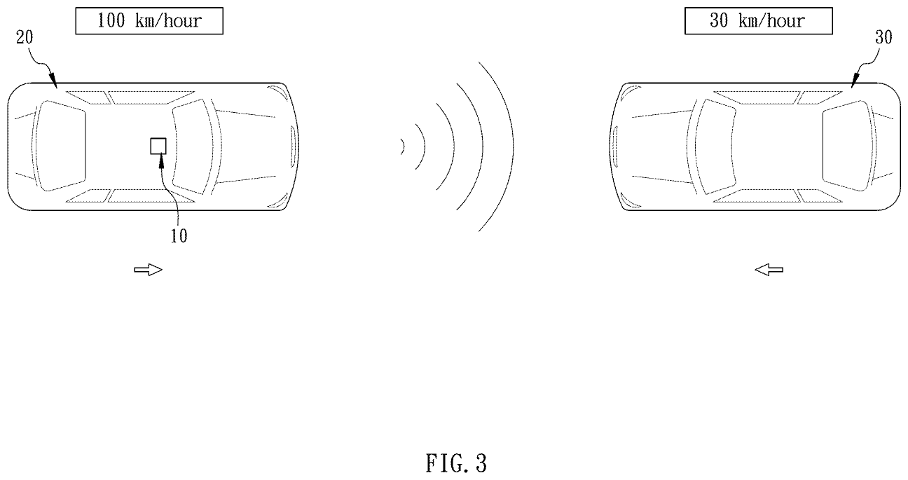

Further referring to FIG. 3, if the first absolute speed of the main vehicle 20 is increased to 100 km/hour, under the same relative speed of 130 km/hour (two vehicles getting closer) or 87 km/hour (two vehicles getting away), the second absolute speed of the target vehicle 30 is either 30 km/hour toward the main vehicle 20 or 187 km/hour away from the main vehicle 20. As a result, the rational speed determination unit 15 determines the smaller possible second absolute speed of the target vehicle 30, which is 30 km/hour toward the main vehicle 20, is the rational second absolute speed.

Based on the foregoing embodiments, the rational speed determination unit 15 determines the rational second absolute speed mainly according to the level of the first absolute speed of the main vehicle 20. In a normal driving environment, the highest speed is limited to 70 km/hour. When the first absolute speed of the target vehicle 20 is 60 km/hour, a possible second absolute speed of the target vehicle 30 of 147 km/hour in an identical direction far exceeds the speed limitation of the road. Therefore, the rational vehicle speed determination 15 determines that the second absolute speed of the target 30 to be 70 km/hour in a counter direction, which meets an speed status of the main vehicle 20 on a road with ordinary speed limit. In a high speed driving environment on the high way where the top speed limitation is 110 km/hour, when the first absolute speed of the target vehicle 20 is 100 km/hour, a possible second absolute speed of the target vehicle 30 of 187 km/hour in an identical direction far exceeds the highest speed limitation. Therefore, the rational speed determination unit 15 determines that the rational second absolute speed of the target vehicle 30 is 30 km/hour in a counter direction, which meets the speed status of the main vehicle 20 facing an incident of vehicle broken down or traffic jam in a high speed driving environment.

In other words, the vehicle speed radar system 10 of the present invention, while maintaining the original frequency sampling range of 9600 Hz (±4800 Hz) of the receiving unit 12, is allowed to determine the ration second absolute speed of the target vehicle 30 according to the first absolute speed of the main vehicle 20, thus being prevented from incorrectly determining that the target vehicle 30 is getting away from the main vehicle 20 in a safe situation. When the target vehicle 30 is getting close to the main vehicle 20 at a high speed in a dangerous situation, a corresponding measure is able to be instantly carried out (such as sending out an alarm), so as to prevent the main vehicle 20 from having collision with the target vehicle 30. Therefore, the cost issue for increasing the frequency sampling range of conventional vehicle speed radar systems are resolved. Also, the main vehicle 20 is effectively prevented from collision with the target vehicle 30.

Also, the signal strength determination unit 16 is able to determine the strength of the reflected wave source which is received, and determines if the target vehicle 30 is getting close to or away from the main vehicle 20 according to the signal strength variation, thus assisting to determine if the relative position between the target vehicle 30 and the main vehicle 20 matches the determination result acquired based on the frequency value, so as to assist the rational speed determination unit 15 to determine the accuracy of the second absolute speed of the target vehicle 30.

In another embodiment of the vehicle speed radar system 10, the rational speed determination unit 15 is applied to define a rational top limitation and a bottom limitation of a rational speed, so as to form a rational relative speed interval. The top limitation and the bottom limitation of the rational speed will increase or decrease according to the variation of the first absolute speed. And only when the possible second absolute speed falls in the rational relative speed interval will the possible second absolute speed be determined as the rational second absolute speed.

Referring to Table 1, when the first absolute speed of the main vehicle 20 falls between 0 km/hour to 40 km/hour, the rational relative speed interval is determined by the rational speed determination unit 15 as ranging from −108 km/hour to +108 km/hour (“+” indicates the two vehicles getting close, “−” indicates the two vehicles getting away), wherein the top limitation and the bottom limitation of the rational speed are −108 km/hour and +108 km/hour, respectively. The extreme values at two ends of the rational relative speed interval are equal, which means that the relative speed range of “getting close” and “getting away” are equal. When the first absolute speed of the main vehicle 20 falls in the range of 40 km/hour to 80 km/hour, the rational relative speed interval determined by the rational speed determination unit 15 falls in the range of −136 km/hour to +80 km/hour, wherein the top limitation and the bottom limitation of the rational relative speeds are −136 km/hour and +80 km/hour, respectively. It can be seen that the rational relative speed interval between “getting close” to “getting away” moves toward the “getting close” direction. Also, when the first absolute speed of the main vehicle 20 falls in the range of 80 km/hour to 120 km/hour, the rational relative speed interval of the second absolute speed of the target vehicle 30 determined by the rational speed determination unit 15 ranges from −156 km/hour to +60 km/hour, wherein the bottom limitation and the top limitation of the rational speed are −156 km/hour and +60 km/hour, respectively. It can be seen that the rational relative speed interval between “getting close” to “getting away” moves further toward the “getting close” direction.

TABLE 1

| | | | |
|---|---|---|---|
| First absolute | 0 to 40 km/hour | 40 to | 80 to |
| speed | | 80 km/hour | 120 km/hour |
| Rational | −108 to | −136 to | −156 to |
| relative | +108 km/hour | +80 km/hour | +60 km/hour |
| speed | | | |
| interval | | | |

For example, the first absolute speed of the main vehicle 20 is 60 km/hour, and the relative speed is 130 km/hour (−130, two vehicles getting close) or 87 km/hour (+87, two vehicles getting away). According to the rational relative speed interval of −136 km/hour to +80 km/hour corresponding to the first absolute speed of 40 km/hour to 80 km/hour, the 130 km/hour (−130, getting close) falls in the rational relative speed interval, while the 87 km/hour (+87, getting away) exceeds the top limitation of the rational relative speed interval. The rational speed determination unit 15, according to the rational speed status above, determines that the target vehicle 30 is getting close to the main vehicle 20 at a second absolute speed of 70 km/hour.

For another example, the first absolute speed of the main vehicle 20 is 100 km/hour, and the relative speed is 130 km/hour (−130, two vehicles getting close) or 87 km/hour (+87, two vehicles getting away). According to the rational relative speed interval of −156 km/hour to +60 km/hour corresponding to the first absolute speed of 80 km/hour to 120 km/hour, the 130 km/hour (−130, getting close) still falls in the rational relative speed interval, while the 87 km/hour (+87, getting away) still exceeds the top limitation of the rational relative speed interval. The rational speed determination unit 15, according to the rational speed status above, determines that the target vehicle 30 is getting close to the main vehicle 20 at a second absolute speed of 30 km/hour.

Therefore, the cost issue for increasing the frequency sampling range of conventional vehicle speed radar systems are resolved. Also, the main vehicle 20 is effectively prevented from collision with the target vehicle 30.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle speed radar system disposed on a main vehicle for determining a relative speed status with respect to a target vehicle, the vehicle radar system comprises:
a transmitting unit sending out a wave source;
a receiving unit receiving the wave source which is reflected by the target vehicle, so as to acquire a frequency value;
a self speed detection unit acquiring a first absolute speed of the main vehicle;
a signal processing unit electrically connected with the receiving unit and the self speed detection unit, so as to acquire at least one relative speed between the main vehicle and the target vehicle, and acquire at least one second absolute speed of the target vehicle based on the first absolute speed and the at least one relative speed; and
a rational speed determination unit electrically connected with the signal processing unit, so as to determine a rational second absolute speed from the at least one second absolute speed.

2. The vehicle speed radar system of claim 1, wherein a plurality of relative speeds are included, and a plurality of second absolute speeds are included, and the rational speed determination unit determines a smallest one of the plurality of second absolute speeds as the rational second absolute speed.

3. The vehicle speed radar system of claim 1, further comprising a signal strength determination unit electrically connected with the receiving unit; when the wave source reflected by the target vehicle is received by the receiving unit, the signal strength determination unit determines a signal strength of the reflected wave source, wherein a gradual rising of the signal strength indicates that the target vehicle is getting closer to the main vehicle, and a gradual reduction of the signal strength indicates that the target vehicle is getting away from the main vehicle.

4. The vehicle speed radar system of claim 1, wherein the rational speed determination unit defines a top limitation and a bottom limitation of a rational speed, so as to form a rational relative speed interval; the top limitation and the bottom limitation of the rational speed increase and decrease according to a variation of the first absolute speed; when one of the at least one second absolute speed falls in the rational relative speed interval, the one of the at least one second absolute speed is determined as the rational second absolute speed.

5. A detection method of the vehicle speed radar system of claim 1, comprising:
(a) the transmitting unit sending a wave source;
(b) the receiving unit receiving the wave source reflected by the target vehicle and acquiring the frequency value;
(c) the self speed detection unit acquiring the first absolute speed of the main vehicle;
(d) the signal processing unit converting the frequency value to acquire the at least one relative speed, and acquiring the at least one second absolute speed of the target vehicle based on the first absolute speed and the at least one relative speed;
(e) the rational speed determination unit determining the rational second absolute speed from the at least one possible second absolute speed.

6. The method of claim 5, wherein a plurality of the relative speeds are included, and a plurality of second absolute speeds are included, and the rational speed determination unit determines a smallest one of the plurality of second absolute speeds as the rational second absolute speed.

7. The method of claim 5, further comprising a signal strength determination unit electrically connected with the receiving unit; when the wave source reflected by the target vehicle is received by the receiving unit, the signal strength determination unit determines a signal strength of the reflected wave source, wherein a gradual rising of the signal strength indicates that the target vehicle is getting closer to the main vehicle, and a gradual reduction of the signal strength indicates that the target vehicle is getting away from the main vehicle.

8. The method of claim 5, wherein the rational speed determination unit defines a top limitation and a bottom limitation of a rational speed, so as to form a rational relative speed interval; the top limitation and the bottom limitation of the rational speed increase and decrease according to a variation of the first absolute speed; when one of the at least one second absolute speed falls in the rational relative speed interval, the one of the at least one second absolute speed is determined as the rational second absolute speed.
